(19) United States
(12) Patent Application Publication
(10) Pub. No.: US 2009/0210326 A1
(43) Pub. Date: Aug. 20, 2009

(54) PURCHASE MANAGEMENT SYSTEM AND METHOD

(75) Inventors: KUNG-CHIEH CHENG, Tu-Cheng (TW); FU-QIANG HE, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/344,456

(22) Filed: Dec. 26, 2008

(30) Foreign Application Priority Data
Feb. 18, 2008 (CN) 200810300353.8

(51) Int. Cl. G06Q 10/00

(52) U.S. Cl. 705/28

(57) ABSTRACT

A purchase management system includes a database, a search module, an order receiving module, a consignment setting module, a receipt management module, and an inspection management module. The database stores order information. The search module acquires the order information from the database responding to a request and outputs the order information. The order receiving module receives the order information and adds the order information to the database. The consignment setting module receives consignment information corresponding to the order information and adds the consignment information to the order information. The receipt management module receives receipt information corresponding to consignment information and adds the receipt information to the order information. The inspection management module receives inspection information corresponding to receipt information adds the inspection information to the order information.

### BACKGROUND

1. Technical Field

The present disclosure relates to supply chain, and more particularly to a purchase management system and method.

2. Description of Related Art

Often, purchasing activities must involve human interaction, wherein, to ascertain the status of a purchase, a purchaser communicates with the supplier by phone or E-mail. However, telephone calls may not be received and emails not received, such that order status remains unknown. Thus, efficiency is detrimentally affected.

Therefore, improved purchase management systems and methods are needed to address the limitations described.

### BRIEF DESCRIPTION OF THE DRAWINGS

FIG. 1 is a pictorial representation of a purchase management system in accordance with an exemplary embodiment.

FIG. 2 is a block diagram of the purchase management system in FIG. 1.

FIG. 3 is a flowchart of a purchase management method in accordance with an exemplary embodiment.

### DETAILED DESCRIPTION OF THE EXEMPLARY EMBODIMENTS

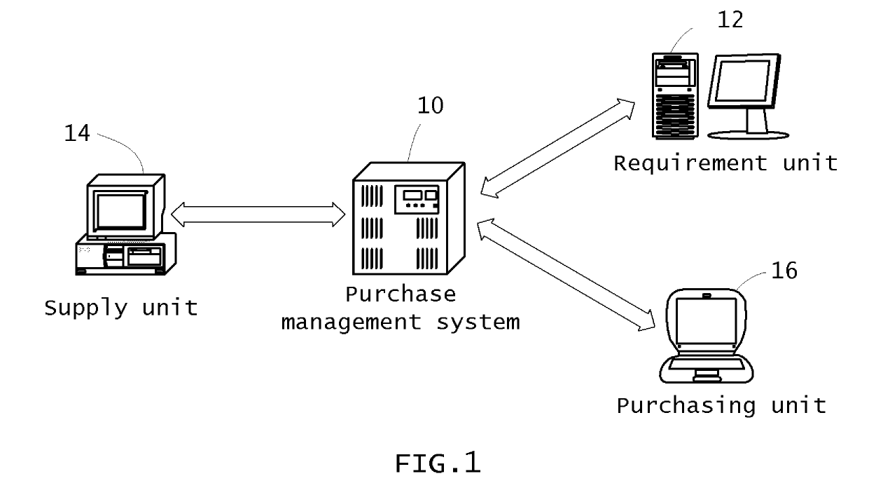

Referring to FIG. 1, a requirement unit 12 used by a requirement department, a supply unit 14 used by a supplier, and a purchasing unit 16 used by a purchaser communicate with a purchase management system 10 via a network such as the Internet. The requirement unit 12, the supply unit 14, and the purchasing unit 16 may be computers.

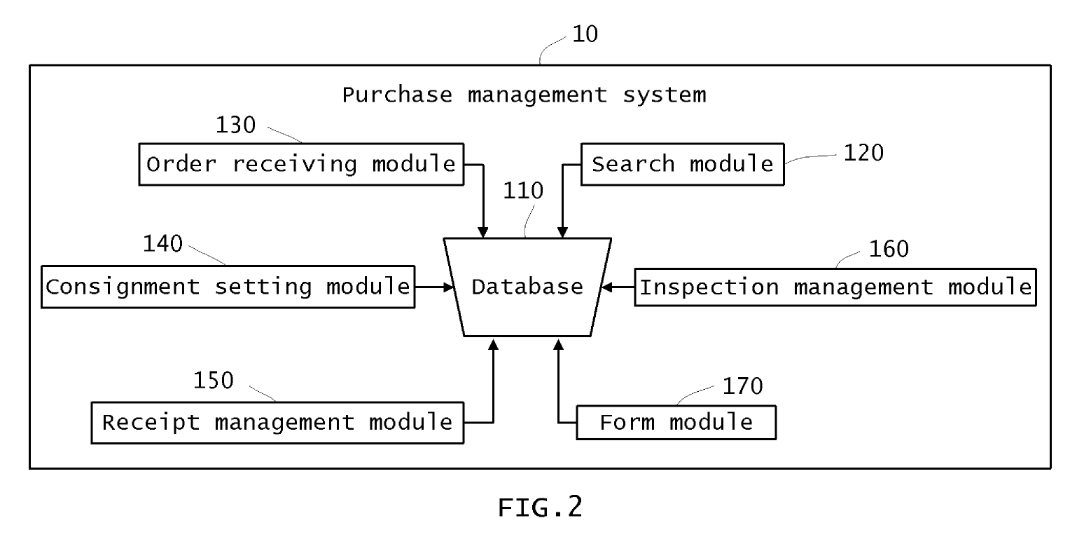

Referring also to FIG. 2, the purchase management system 10 includes a database 110, a search module 120, an order receiving module 130, a consignment setting module 140, a receipt management module 150, an inspection management module 160, and a form module 170.

The database 110 stores order information. The order information may include the requirement department name, name and quantity of desired goods, order time, and delivery time. The order information may be input into the purchase management system 10 by item by the requirement department using the requirement unit 12.

The search module 120 acquires order information from the database 100 in response to a user request, one of the requirement department, the supplier, and the purchaser, and outputs the order information to the user, so that the requirement department, the supplier and the purchaser acquire the order status.

The order receiving module 130 receives the order information input by the requirement department using the requirement unit 12 and adds the order information to the database 110, such that the supplier and the purchaser receive the order information using the supply unit 14, the purchasing unit 16, and the search module 120.

The consignment setting module 140 receives consignment information, corresponding to the order information from the requirement unit 12, input by the supplier using the supply unit 14, and adds the consignment information to the order information, such that the requirement department 12 and the purchaser 16 receive the consignment information via the requirement department 12, the purchasing unit 16, and the search module 120. The consignment information may include a name of the supplier, a name and quantity of consignment goods, and consignment time.

The receipt management module 150 receives receipt information, corresponding to the consignment information from the supply unit 14, input by the purchaser using the purchasing unit 16, and adds the receipt information to the order information, such that the requirement department and the supplier receive the receipt information via the requirement unit 12, the supply unit 14, and the search module 120. When the purchaser confirms that received goods are in accordance with the consignment information from the supply unit 14, the purchaser inputs the receipt information into the purchase management system 10 using the purchasing unit 16. The receipt information may include a name of the purchaser, a name and quantity of receipt goods, and receipt time.

The inspection management module 160 receives inspection information, corresponding to the receipt information from the purchasing unit 16, input by the requirement department using the requirement unit 12, and adds the inspection information to the order information, such that the supplier and the purchaser receive the inspection information via the supply unit 14, the purchasing unit 16, and the search module 120. The inspection information is “purchase” or “return”. When the inspection information is “purchase”, the inspection management module 160 adds the status of the corresponding order “finish”, to the order information, denoting that a purchase corresponding to the order is complete. When the inspection information is “return”, the inspection management module 160 adds the status of the corresponding order “return”, to the order information, whereby the supplier re-consigns the desired purchase goods of the order from the requirement unit 12.

The form module 170 produces a form corresponding to the order information in response to a user request, the requirement department, the supplier, or the purchaser, and outputs the form to the user.

In sum, the requirement department, the supplier, and the purchaser can view the status of the order by the requirement unit 12, the supply unit 14, the purchasing unit 16, and the purchase management system 10. Purchase process is simplified and efficiency improved.

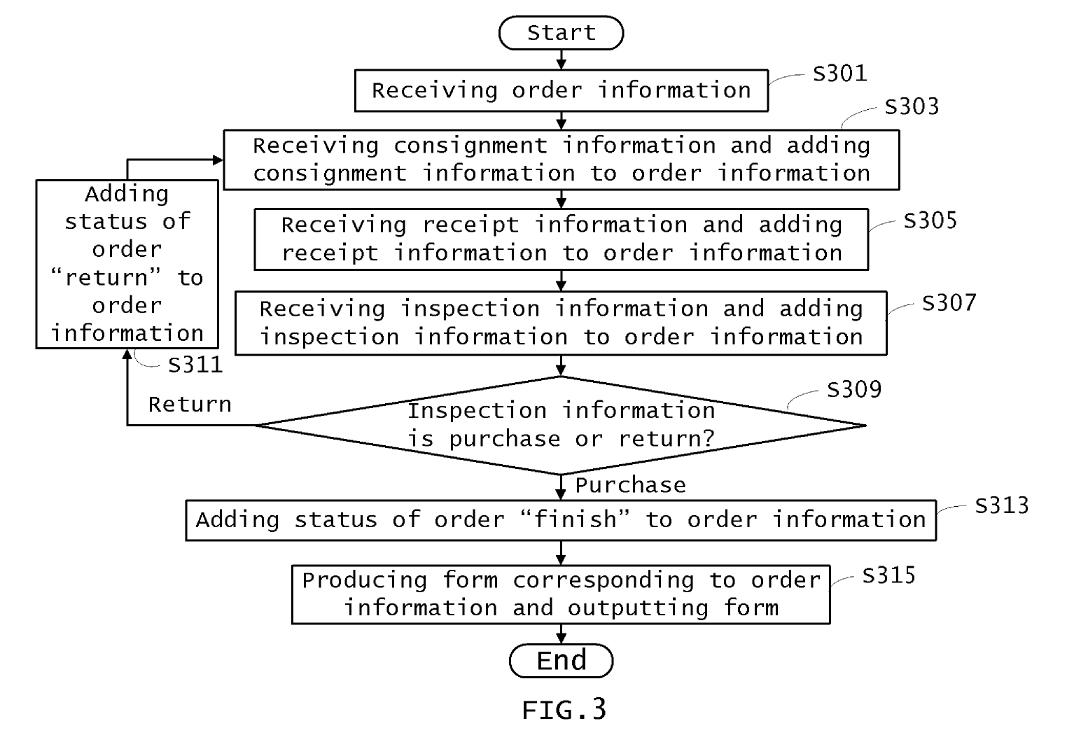

Referring to FIG. 3, a purchase management method in accordance with an exemplary embodiment is shown. The purchase management method may be implemented using the purchase management system 10 (FIG. 2). The various actions in the purchase management method may be performed in the order presented, or may be performed in a different order. Furthermore, in some embodiments, some actions listed in FIG. 3 may be omitted from the purchase management method.

In step S301, order information input by a requirement department using a requirement unit 12 is received.

In step S303, consignment information is received, corresponding to the order information from the requirement unit 12, input by a supplier using a supply unit 14 and adding the consignment information to the order information.

In step S305, receipt information corresponding to the consignment information is received from the supply unit 14, input by a purchaser using purchasing unit 16 and adding the receipt information to the order information.

In step S307, inspection information corresponding to the consignment from the purchasing unit 16 is received, input by the requirement department using the requirement unit 12 and adding the inspection information to the order information.

In step S309, the inspection information is determined to be “purchase” or “return”. If the inspection information is “return”, step S311 is implemented and S303 repeated. If the inspection information is “purchase”, step S313 is implemented.

In step S311, status of the order “return” is added to the order information so that the supplier re-consigns desired purchased goods of the order from the requirement unit 12.

In step S313, status of the order “finish” is added to the order information, denoting that a purchase corresponding to the order is complete.

In step S315, a form corresponding to the order information is produced in response to a user request, the requirement department, the supplier, or the purchaser, and output to the user.

It is to be understood, however, that even though numerous information and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A purchase management system comprising:
a database storing order information;
a search module acquiring the order information from the database responding to a request and outputting the order information;
an order receiving module receiving the order information input by a requirement department using a requirement unit and adding the order information to the database;
a consignment setting module receiving consignment information, corresponding to the order information, input by a supplier using a supply unit and adding the consignment information to the order information;
a receipt management module receiving receipt information, corresponding to consignment information, input by a purchaser using a purchasing unit and adding the receipt information to the order information; and
an inspection management module receiving inspection information, corresponding to receipt information, input by the requirement department and adding the inspection information to the order information.

2. The purchase management system according to claim 1, wherein the order information is input into the purchase management system by item.

3. The purchase management system according to claim 1, wherein the inspection information is “purchase” or “return”, and wherein, when the inspection information is “purchase”, the inspection management module adds status of the order “finish” to the order information, and when the inspection information is “return”, the inspection management module adds the status of the order “return” to the order information.

4. The purchase management system according to claim 1, further comprising a form module producing a form corresponding to the order information responding to a request and outputting the form.

5. The purchase management system according to claim 1, wherein the requirement unit, the supply unit, and the purchasing unit are computers connecting with the purchase management system via a network.

6. A purchase management method comprising:
receiving order information;
receiving consignment information and adding the consignment information to the order information;
receiving receipt information and adding the receipt information to the order information
receiving inspection information and adding the inspection information to the order information; and
determining whether the inspection information is “purchase” or “return”, and, wherein, when the inspection information is “purchase” adding status of the order “finish” to the order information.

7. The purchase management method according to claim 6, further comprising:
adding the status of the order “return” to the order information and then returning to consignment information receipt and adding the consignment information to the order information when the inspection information is the “return”.

8. The purchase management method according to claim 6, further comprising:
producing a form corresponding to the order information responding to a request and outputting the form.
